(19) United States
(12) Patent Application Publication
(10) Pub. No.: US 2021/0323797 A1
(43) Pub. Date: Oct. 21, 2021

(54) ROTARY TOWER CRANE HAVING A TOWER MAST THAT CONSISTS OF A PLURALITY OF TOWER SECTIONS

(71) Applicant: LIEBHERR-WERK BIBERACH GMBH, Biberach an der Riss (DE)

(72) Inventor: Eric KONIJN, Singapore (SG)

(73) Assignee: LIEBHERR-WERK BIBERACH GMBH, Biberach an der Riss (DE)

(21) Appl. No.: 16/973,267

(22) PCT Filed: Jun. 14, 2019
(86) PCT No.: PCT/EP2019/065711

§ 371 Date: Jun. 25, 2021

(30) Foreign Application Priority Data
Jun. 15, 2018 (DE) 10 2018 114 421.0

(51) Int. Cl. B66C 23/60; B66C 23/02

(52) U.S. Cl. CPC B66C 23/60; B66C 23/025; B66C 23/022

(57) ABSTRACT

The invention relates to a rotary tower crane (10) having a tower mast (2) at the upper end of which a jib (8) is arranged, at least part of the tower mast being formed by at least three parallel tower sections (7) arranged next to one another.

The present invention relates to a revolving tower crane in accordance with the preamble of claim 1.

Revolving tower cranes of the category comprise a crane tower and a crane boom arranged at its upper end. With top-slewing cranes, the boom, that typically comprises a main boom and a counterboom, is connected to the upper end of the crane tower via a slewing gear, whereas with bottom-slewing cranes, the tower and boom are rigidly connected to one another and the crane tower stands on a rotatable undercarriage.

When building high constructions, correspondingly high cranes are required having hook heights of over 100 m in part. The possibility is frequently made use of here of anchoring or guying cranes at the construction to be built and of increasing the height of the crane or its hook height by “climbing”. The term “climbing” here designates the subsequent introduction of tower sections into the crane tower to adapt the height of the crane to the increasing height of the construction.

Cases are, however, problematic in which an anchorage or guying of the crane at the construction being built is not possible, for example on a use of prefabricated members that cannot take up the required guying forces. Free-standing crane structures accordingly have to be used in such cases. In particular the increasing use of prefabricated concrete parts in high buildings therefore represents a great challenge for the use of correspondingly high cranes.

To nevertheless reach great heights with free-standing cranes, there is the option of connecting the lower end of the crane tower or crane section connected to the boom to an additional tower section having greater external dimensions by means of a transition section. However, the additional wider crane tower is extremely cost intensive and there is frequently low availability.

It is therefore the underlying object of the present invention to provide a revolving tower crane having a large hook height whose tower structure is based on inexpensive and easily available components.

This object is achieved in accordance with the invention by a revolving tower crane having the features of claim 1. A revolving tower crane is accordingly provided having a tower structure at whose upper end a boom is arranged, wherein in accordance with the invention at least some of the tower structure is formed by at least three parallel tower sections arranged next to one another.

The idea in accordance with the invention comprises assembling at least some of the tower structure of a revolving tower crane from a plurality of individual crane towers or tower sections and thereby achieving a greater hook height of the crane. The at least three parallel tower sections are here preferably crane towers or tower sections of different crane types, in particular smaller crane types. Such a tower structure makes it possible to use tower sections of other, ideally easily available crane systems and in so doing achieves the required stability to implement a tower structure having a great height.

Advantageous embodiments of the invention result from the dependent claims and from the following description.

Provision is made in an embodiment that some of the tower structure is formed by a single tower section that is preferably wider than each of the at least three parallel tower sections. The individual tower section is here in particular located above the at least three parallel tower sections.

The use of smaller tower sections arranged in parallel next to one another makes possible an economically advantageous extension of the tower structure of revolving tower cranes. Crane towers of smaller crane systems can, for example, be used for the smaller tower sections. This is in particular economically advantageous when the smaller crane systems are anyway present and are used less, for example due to a low workload. A plurality of smaller tower sections arranged in parallel next to one another furthermore frequently achieve a higher stability than a single wider tower section.

Provision is made in a further embodiment that a transition section is arranged above the at least three parallel tower sections and connects them to one another.

Provision is made in a further embodiment that the transition section has an upwardly tapering conical shape and is preferably designed as a lattice element, as a tower section, or as a frame, for example as a sheet metal design.

Provision is made in a further embodiment that the transition section connects the at least three parallel tower sections to a single tower section, with the single tower section preferably being wider than each of the parallel tower sections.

The transition section therefore so-to-say acts as an adapter section that connects the thicker crane tower or the single tower section to the at least three parallel tower sections. Provision can alternatively also be made that the crane boom is directly fastened, either rotatably or rigidly, to the transition section. In this case, the total tower structure is formed by the at least three parallel tower sections and the transition section.

Provision is made in a further embodiment that the at least three parallel tower sections are connected to a foundation cross or to an undercarriage via foundation anchors. It is also possible that a further lower transition section is provided that connects the lower ends of the at least three parallel tower sections to one another and that is in turn connected to the foundation cross or to the undercarriage. In this case, a particularly simple retrofittability of the revolving tower crane in accordance with the invention would result. For the retrofitting, the single wider crane tower is simply released from the foundation cross or undercarriage and the at least three parallel tower sections are inserted between the upper and lower transition sections.

Provision is made in a further embodiment that the at least three parallel tower sections represent independent crane towers or at least parts thereof that can be used in other revolving tower cranes.

Provision is made in a further embodiment that the wider single tower section represents an independent crane tower or at least a part thereof that can be used in another revolving tower crane.

Provision is made in a further embodiment that the at least three parallel tower sections are connected to one another by reinforcement portions. The stability of the tower structure in accordance with the invention is thereby further increased. Provision can be made here that the individual tower sections are connected to one another by crossmembers, bracing portions, lattice sections, or other reinforcement portions.

The present invention further comprises a transition section for connecting at least three parallel tower sections of a revolving tower crane in accordance with one of the claims 3 to 5.

Further features, details, and advantages of the invention result from the embodiments explained with reference to the Figures. There are shown:

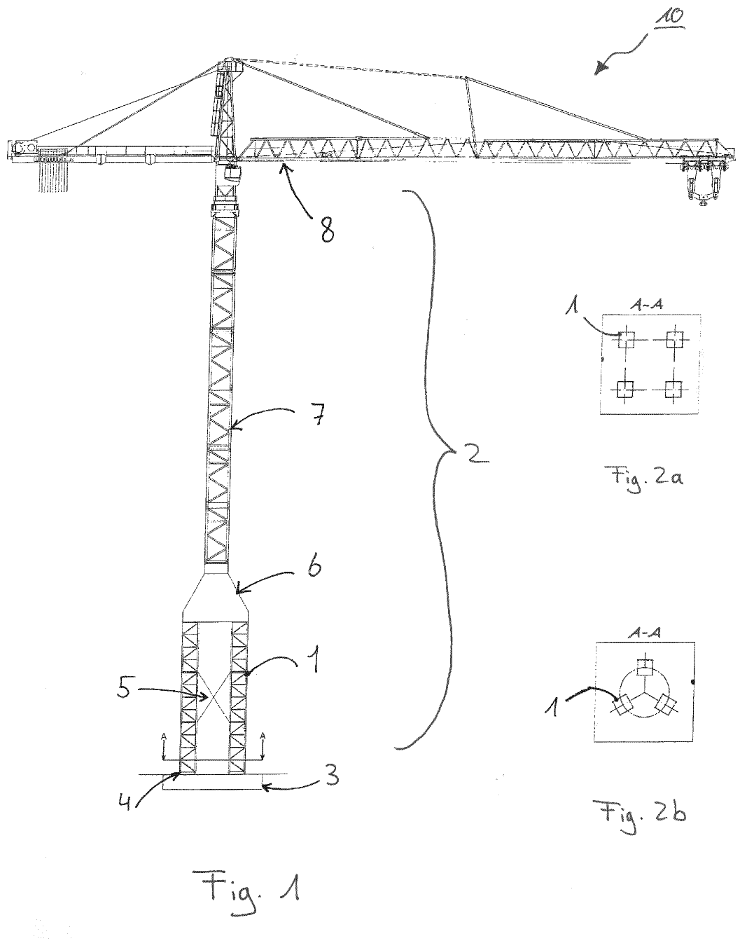

FIG. 1: an embodiment of the revolving tower crane in accordance with the invention in a side view;

FIG. 2a: a cross-sectional plan view through the lower portion of the tower structure of the embodiment in accordance with FIG. 1 with four parallel tower sections; and

FIG. 2b: an alternative embodiment of the revolving tower crane in accordance with the invention with three parallel tower sections in a cross-sectional plan view through the lower portion of the tower structure.

An embodiment of the revolving tower crane 10 in accordance with the invention is shown in a side view in FIG. 1. The revolving tower crane 10 is designed as a top-slewing crane and has a tower structure 2 to whose upper end a boom 8, comprising a main boom and a counterboom, is rotatably fastened via a slewing gear.

The tower structure 2 has three portions. The upper portion that is connected to the boom 8 is formed by a single tower section 7. The lower portion that is connected to the crane foundation 3 is formed by four parallel tower sections 1 that are arranged next to one another and that each have a smaller width or outer periphery than the single tower section 7. The smaller tower sections 1 here form the corners of a square and are connected to the single wider tower section 7 via a conically shaped transition section 6 (middle portion). To increase the stability, the smaller tower sections 1 are connected to one another by additional reinforcement portions.

The smaller tower sections 1 are connected via foundation anchors 4 to a crane foundation 3 which can, for example, be a foundation cross. The revolving tower crane 10 in accordance with the invention can alternatively be a bottom-slewing crane. In this case, the smaller tower sections 1 can be connected to a rotatable undercarriage of the crane 10. It is likewise possible that the smaller tower sections 1 are connected to a further transition section that is in turn connected to a foundation cross or undercarriage.

A section (plan view) marked by the arrows marked by “A” through the lower section of the tower structure 2 is shown in FIG. 2a. It can be recognized that the four parallel tower sections 1 form the corners of a square, whereby a high stability of the tower structure 2 is ensured.

An alternative embodiment having only three smaller parallel tower sections 1 is shown in FIG. 2b that represents the same cross-sectional view as FIG. 2a. The three smaller tower sections 1 are placed rotated with respect to one another here and form the corners of an equilateral triangle. A high stability is likewise hereby achieved, with a smaller tower section 1 being used less than in the embodiment of FIGS. 1 and 2a. It is, however, also possible to use a smaller number or arrangement of the smaller tower sections 1 for the tower structure 2 depending on the demand on stability, hook height, economy, etc.

The invention is based on the insight that a plurality of smaller tower sections 1 can enable a more stable crane tower configuration than a single wider or thicker tower section 7. Smaller tower sections 1 of other crane systems are furthermore typically available more favorably and better on the market than larger crane towers 7. Tower sections 1 of smaller crane systems are frequently kept ready without being used and can thus be used simply and inexpensively in the tower structure 2 of a revolving tower crane 10 in accordance with the invention.

A tower system can, for example, be built by the use of four tower sections 1 of the type Liebherr 120 HC that is stronger, more stable, and, with respect to the price per meter, less expensive than a single larger crane tower of the type 1250 HC. It is thereby possible to provide e.g. free-standing cranes of the type Liebherr 550/630/1000 EC-H with hook heights of over 100 m. Smaller tower sections of the type 120 HC are furthermore more economical in assembly and are better available on the market than larger tower sections of the type 1250 HC.

### REFERENCE NUMERAL LIST

1 tower section
2 tower structure
3 crane foundation
4 foundation anchors
5 reinforcement portion
6 transition section
7 tower section
8 boom
10 revolving tower crane

1. A revolving tower crane (10) having a tower structure (2) at whose upper end a boom (8) is arranged, wherein at least some of the tower structure (2) is formed by at least three parallel tower sections (1) arranged next to one another.

2. A revolving tower crane (10) in accordance with claim 1, wherein some of the tower structure (2) is formed by a single tower section (7) that is preferably wider than each of the at least three parallel tower sections (1).

3. A revolving tower crane (10) in accordance with claim 1, wherein a transition section (6) is arranged above the at least three parallel tower sections (1) and connects them to one another.

4. A revolving tower crane (10) in accordance with claim 3, wherein the transition section (6) has an upwardly tapering conical shape and is preferably designed as a lattice element, as a tower section, or as a frame.

5. A revolving tower crane (10) in accordance with claim 3, wherein the transition section (6) connects the at least three parallel tower sections (1) to a single tower section (7), with the single tower section (7) preferably being wider than each of the parallel tower sections (1).

6. A revolving tower crane (10) in accordance with claim 1, wherein the at least three parallel tower sections (1) are connected to a foundation cross (3) or tan undercarriage of the revolving tower crane (10) via foundation anchors (4).

7. A revolving tower crane (10) in accordance with claim 1, wherein the at least three parallel tower sections (1) represent independent crane towers or at least parts thereof that can be used in other revolving tower cranes.

8. A revolving tower crane (10) in accordance with claim 2, wherein the single tower section (7) represents an independent crane tower or at least a part thereof that can be used in another revolving tower crane.

9. A revolving tower crane (10) in accordance with claim 1, wherein the at least three parallel tower sections (1) are connected to one another by reinforcement portions (5).

10. A transition section (6) for connecting at least three parallel tower sections (1) of a revolving tower crane (10) in accordance with claim 3.

11. A revolving tower crane (10) in accordance with claim 2, wherein a transition section (6) is arranged above the at least three parallel tower sections (1) and connects them to one another.

12. A revolving tower crane (10) in accordance with claim 11, wherein the transition section (6) has an upwardly tapering conical shape and is preferably designed as a lattice element, as a tower section, or as a frame.

13. A revolving tower crane (10) in accordance with claim 12, wherein the transition section (6) connects the at least three parallel tower sections (1) to a single tower section (7), with the single tower section (7) preferably being wider than each of the parallel tower sections (1).

14. A revolving tower crane (10) in accordance with claim 4, wherein the transition section (6) connects the at least three parallel tower sections (1) to a single tower section (7), with the single tower section (7) preferably being wider than each of the parallel tower sections (1).

15. A revolving tower crane (10) in accordance with claim 14, wherein the at least three parallel tower sections (1) are connected to a foundation cross (3) or an undercarriage of the revolving tower crane (10) via foundation anchors (4).

16. A revolving tower crane (10) in accordance with claim 13, wherein the at least three parallel tower sections (1) are connected to a foundation cross (3) or an undercarriage of the revolving tower crane (10) via foundation anchors (4).

17. A revolving tower crane (10) in accordance with claim 12, wherein the at least three parallel tower sections (1) are connected to a foundation cross (3) or an undercarriage of the revolving tower crane (10) via foundation anchors (4).

18. A revolving tower crane (10) in accordance with claim 11, wherein the at least three parallel tower sections (1) are connected to a foundation cross (3) or an undercarriage of the revolving tower crane (10) via foundation anchors (4).

19. A revolving tower crane (10) in accordance with claim 5, wherein the at least three parallel tower sections (1) are connected to a foundation cross (3) or an undercarriage of the revolving tower crane (10) via foundation anchors (4).

20. A revolving tower crane (10) in accordance with claim 4, wherein the at least three parallel tower sections (1) are connected to a foundation cross (3) or an undercarriage of the revolving tower crane (10) via foundation anchors (4).
